(19) United States
(12) Patent Application Publication
(10) Pub. No.: US 2012/0262476 A1
(43) Pub. Date: Oct. 18, 2012

(54) PIXEL CONVERSION SYSTEM AND METHOD

(75) Inventor: Yung-Yu Lee, Tainan City (TW)

(73) Assignee: HIMAX TECHNOLOGIES LIMITED, Tainan City (TW)

(21) Appl. No.: 13/085,901

(22) Filed: Apr. 13, 2011

(51) Int. Cl. G09G 5/02

(52) U.S. Cl. 345/603

(57) ABSTRACT

A pixel conversion system and method are disclosed. A pixel converter converts an original pixel to a converted pixel, wherein at least one subpixel is additionally generated. A scaling down unit scales down the converted subpixels and the generated subpixel of the converted pixel, thereby resulting in a plurality of scaled subpixels.

### BACKGROUND OF THE INVENTION

1. Field of the Invention

The present invention generally relates to pixel conversion, and more particularly to RGB-to-RGBW conversion for a display device.

2. Description of Related Art

A display panel such as a liquid crystal display (LCD) is consisted of array of pixels. Each pixel has red (R), green (G) and blue (B) subpixels, which may be mixed to generate a variety of colors. A new pixel scheme has been proposed to add a white (W) subpixel to the traditional R, G and B subpixels. According to the new pixel scheme, white color, for example, may be displayed directly by the W subpixel rather than mixing the R, G and B subpixels. As a result, a brighter display and less power consumption can be achieved.

As the W subpixels are additionally added in the new pixel scheme, the amount of the source driver channels in the LCD becomes 4/3 times the original channels. The increment of the channels, however, not only increases the overall cost, but also complicates the display system design.

An alternative scheme is proposed to maintain the amount of the source driver channels in the LCD, for example, by truncating some of the R, G, B and W subpixels. Although this scheme can overcome the cost and design problem as mentioned above, unwanted sawtooth distortion commonly occurs, therefore degrading the display quality.

For the reason that the conventional RGB-to-RGBW techniques either increase cost and design complexity or degrade display quality, a need has arisen to propose a novel pixel conversion scheme that may increase display brightness and reduce power consumption without sacrificing the display quality.

### SUMMARY OF THE INVENTION

In view of the foregoing, it is an object of the embodiment of the present invention to provide a pixel conversion scheme that may achieve brighter display and less power consumption in a cost effective manner without degrading display quality.

According to one embodiment, the pixel conversion system includes a pixel converter and a scaling down unit. The pixel converter is configured to convert an original pixel to a converted pixel, wherein the original pixel includes a plurality of original subpixels, and the converted pixel includes a plurality of converted subpixels and at least one additionally generated subpixel, the plurality of converted subpixels being respectively corresponding to the plurality of original subpixels. The scaling down unit is configured to scale down the plurality of converted subpixels and the generated subpixel, thereby resulting in a plurality of scaled subpixels that are respectively corresponding to the plurality of converted subpixels and the generated subpixel.

### BRIEF DESCRIPTION OF THE DRAWINGS

FIG. 1 shows a block diagram of a pixel conversion system;

FIG. 2 shows exemplary original RGB subpixels and converted RGBW subpixels;

FIG. 3 shows a block diagram of the pixel converter in FIG. 1,

FIG. 4A schematically shows exemplary converted pixels and scaled pixels;

FIG. 4B and FIG. 4C schematically demonstrate the linear interpolation performed on some converted subpixels; and

FIG. 5 schematically shows exemplary converted RGBW subpixels and scaled RGBW subpixels.

### DETAILED DESCRIPTION OF THE INVENTION

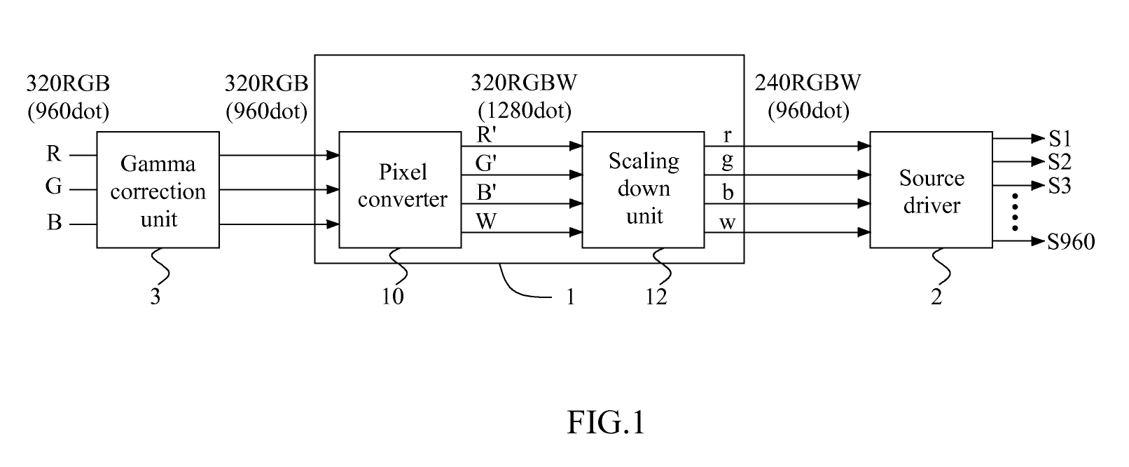

FIG. 1 shows a block diagram of a pixel conversion system 1 that generates at least one additional subpixel (or dot) per pixel according to one embodiment of the present invention. In the embodiment, each original pixel includes red (R), green (G) and blue (B) original subpixels, and the converted pixel includes R, G, B converted subpixels and an additionally generated white (W) subpixel. While the RGB-to-RGBW pixel conversion system is illustrated in the following embodiment, it is appreciated that the present invention may be well adapted to other pixel conversion system with different subpixels configuration.

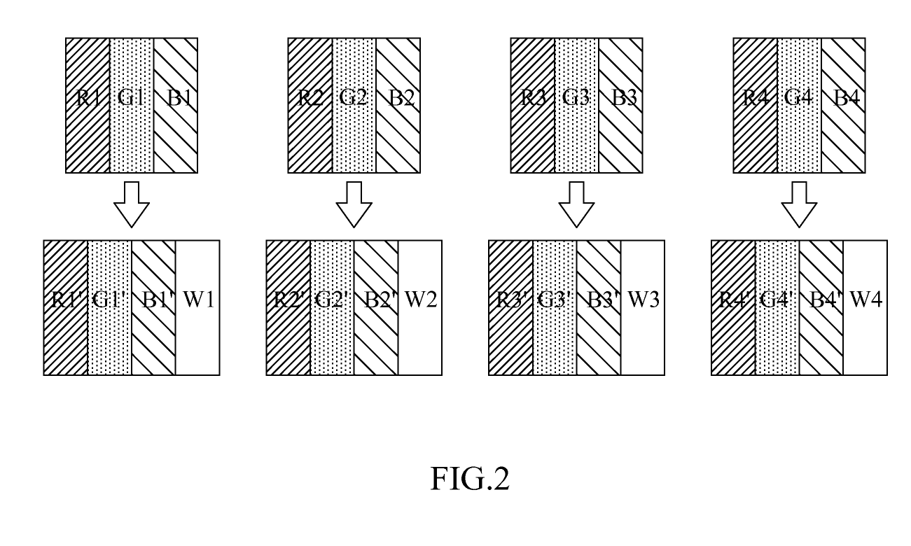

The pixel conversion system 1 includes, in the embodiment, a pixel converter 10 and a scaling down unit 12. Specifically, the pixel converter 10, such as a RGB-to-RGBW converter, receives the original pixel of R, G and B original subpixels and converts the original pixel to the converted pixel of R′, G′, B′ converted subpixels and W generated subpixel as illustrated in FIG. 2. As exemplified in FIG. 1, it is assumed that a display device such as liquid crystal display (LCD) has a resolution of 320 pixels (or 960 subpixels or dots) per scan line. Accordingly, the converted, pixels of R′, G′, B′ and W subpixels thus have 1280 subpixels or dots per scan line. In the embodiment, the pixel conversion adopts, but is not limited to, the following algorithm:

mx=Max(R,G,B)

mn=(R,G,B)=W

R′=R*(1+mn/255)−(mx/255)*W

G′=G*(1+mn/255)−(mx/255)*W

B′=B*(1+mn/255)−(mx/255)*W

where Max is a function that selects the greatest value in the set of R, G and B, and Min is a function that selects the least value in the set of R, G and B.

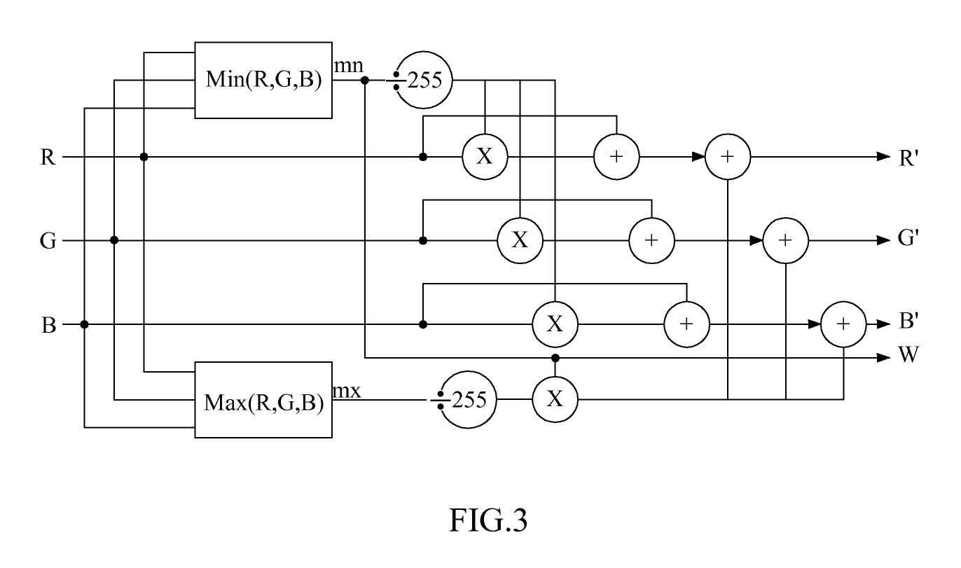

Generally speaking, according to the above conversion algorithm, the generated W subpixel is equal to the least value among the R, G and B original subpixels, the R′ converted subpixel is determined according to the R original subpixel and the W generated subpixel, the G′ converted subpixel is determined according to the G original subpixel and the W generated subpixel, and the B′ converted subpixel is determined according to the B original subpixel and the W generated subpixel. FIG. 3 shows a block diagram of the pixel converter 10 corresponding to the algorithm mentioned above.

Subsequently, the scaling down unit 12 receives the converted R′, G′, B′ and W subpixels, and then scales down the converted R′, G′, B′ and W subpixels, therefore generating r, g, b and w scaled subpixels. As a result, the r, g, and w scaled subpixels can fit into the resolution of the display device. For example, it is assumed that the display device has the resolution of 960 subpixels (or dots) per scan line. The scaling down unit 12 scales the 1280 subpixels down to 960 subpixels per scan line. It is appreciated that the resultant resolution of the scaled pixels is not necessarily the same as that of the converted pixels.

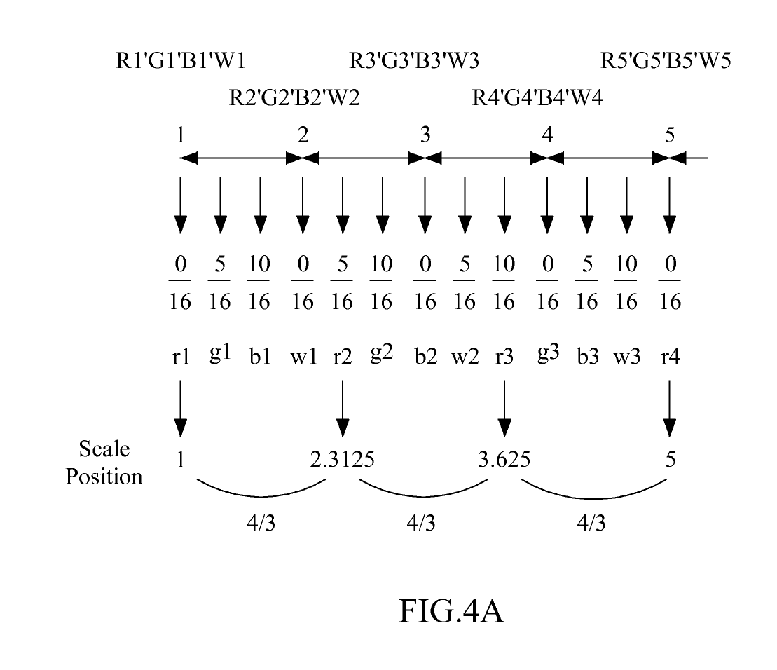

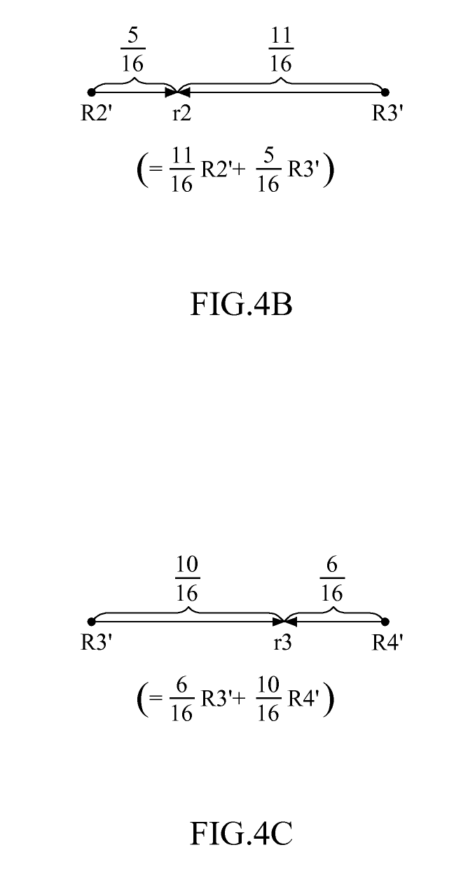

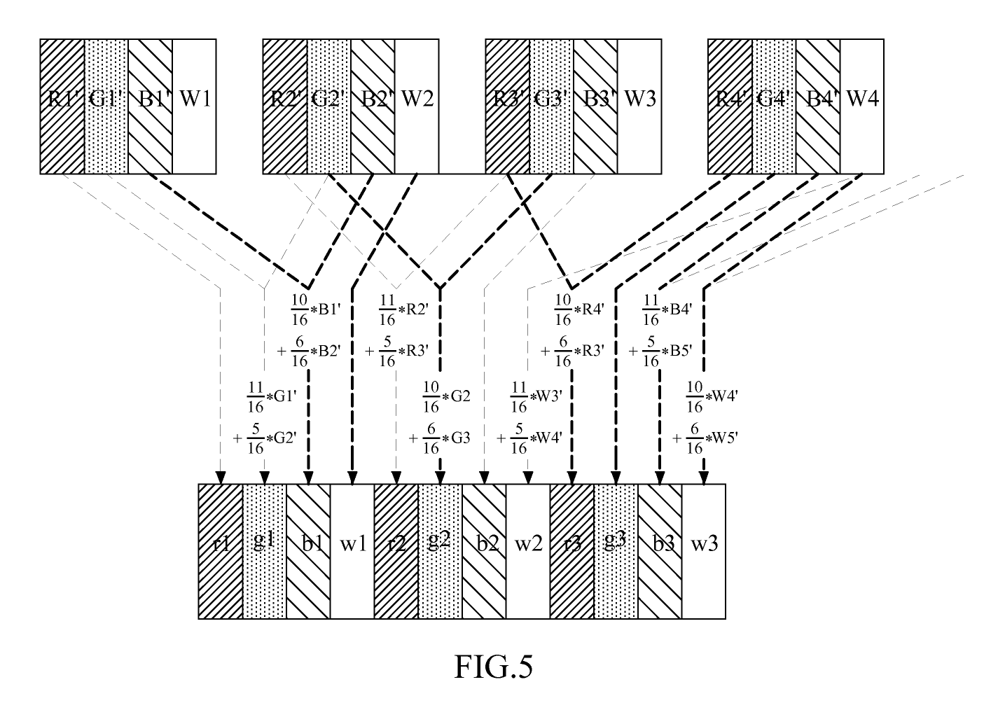

In the embodiment, a linear interpolation is adopted to perform the scaling down operation. Although the linear interpolation is used in the embodiment, it is appreciated that other interpolation techniques may be well adopted. FIG. 4A schematically shows five exemplary converted pixels R1′/G1′/B1′/W1 through R5′/G5′/B5′/W5, and four scaled pixels r1/g1/b1/w1 through r4/g4/b4/w4. It is assumed that 4 bits are adopted in this example such that there are 16 divisions between two adjacent converted pixels. FIG. 4B schematically demonstrates the linear interpolation performed on the converted subpixels R2′ and R3′ in order to obtain a scaled subpixel r2. FIG. 4C schematically further demonstrates the linear interpolation performed on the converted subpixels R3′ and R4′ in order to obtain a scaled subpixel r3. Other scaled subpixels may also be obtained according to the linear interpolation as shown in FIG. 5.

After performing the scaling down on the converted subpixels, the resultant r, g, b, and w scaled subpixels may then be fed to a source driver 2 that conforms to the resolution of the display device. The source driver 2 then outputs data, for example, to LCD panel via data lines. As exemplified in FIG. 1, the amount (e.g., 960) of channels in the source driver 2 is the same as the number of subpixels inputting to the RGB-to-RGBW converter 10. Furthermore, a gamma correction unit 3 may be used, prior to the pixel converter 10, to perform gamma encoding on the original pixels of R, G and B original subpixels. According to the embodiment as described above, the sawtooth distortion commonly occurred in the conventional RGB-to-RGBW conversion can be substantially improved.

Although specific embodiments have been illustrated and described, it will be appreciated by those skilled in the art that various modifications may be made without departing from the scope of the present invention, which is intended to be limited solely by the appended claims.

What is claimed is:

1. A pixel conversion system, comprising:
a pixel converter configured to convert an original pixel to a converted pixel, wherein the original pixel includes a plurality of original subpixels, and the converted pixel includes a plurality of converted subpixels and at least one additionally generated subpixel, the plurality of converted subpixels being respectively corresponding to the plurality of original subpixels; and
a scaling down unit configured to scale down the plurality of converted subpixels and the generated subpixel, thereby resulting in a plurality of scaled subpixels that are respectively corresponding to the plurality of converted subpixels and the generated subpixel.

2. The system of claim 1, wherein the plurality of original subpixels comprise red (R), green (G) and blue (B) original subpixels, the plurality of converted subpixels comprise R, G and B converted subpixels, the at least one additionally generated subpixel comprises a white (W) subpixel, and the plurality of scaled subpixels comprise R, G, B and W scaled subpixels.

3. The system of claim 2, wherein the W subpixel is equal to the least value among the R, G and B original subpixels.

4. The system of claim 3, wherein the R converted subpixel is determined according to the R original subpixel and the W subpixel, the G converted subpixel is determined according to the G original subpixel and the W subpixel, and the B converted subpixel is determined according to the B original subpixel and the W subpixel.

5. The system of claim 4, wherein, the pixel converter performs following:
mx=Max(R,G,B)
mn=(R,G,B)=W
R′=R*(1+mn/255)−(mx/255)*W
G′=G*(1+mn/255)−(mx/255)*W
B′=B*(1+mn/255)−(mx/255)*W
wherein R, G and B respectively represent R, G and B original subpixels, R′, G′ and B′ respectively represent R, G and B converted subpixels, W represents the W subpixel, Max is a function that selects a greatest value in the set of R, G and B, and Min is a function that selects a least value in the set of R, G and B.

6. The system of claim 1, wherein the plurality of scaled subpixels are determined by performing interpolation on the plurality of converted subpixels and the generated subpixel.

7. The system of claim 6, wherein the interpolation is linear interpolation.

8. The system of claim 2, wherein the R, G, B and W scaled subpixels are respectively determined by performing linear interpolation on the R, G and B converted subpixels and the W subpixels.

9. The system of claim 1, further comprising a source driver configured to receive the plurality of scaled subpixels and then output a plurality of data.

10. The system of claim 1, further comprising a gamma correction unit configured to perform gamma encoding on the plurality of original subpixels prior to the pixel converter.

11. A pixel conversion method, comprising:
converting an original pixel to a converted, pixel, wherein the original pixel includes a plurality of original subpixels, and the converted pixel includes a plurality of converted subpixels and at least one additionally generated subpixel, the plurality of converted subpixels being respectively corresponding to the plurality of original subpixels; and
scaling down the plurality of converted subpixels and the generated subpixel, thereby resulting in a plurality of scaled subpixels that are respectively corresponding to the plurality of converted subpixels and the generated subpixel.

12. The method of claim 11, wherein the plurality of original subpixels comprise red (R), green (G) and blue (B) original subpixels, the plurality of converted subpixels comprise R, G and B converted subpixels, the at least one additionally generated subpixel comprises a white (W) subpixel, and the plurality of scaled subpixels comprise R, G, B and W scaled subpixels.

13. The method of claim 12, in the step of converting the original pixel, the W subpixel is equal to the least value among the R, G and B original subpixels.

14. The method of claim 13, in the step of converting the original pixel, the R converted subpixel is determined according to the R original subpixel and the W subpixel, the G converted subpixel is determined according to the G original subpixel and the W subpixel, and the B converted subpixel is determined according to the B original subpixel and the W subpixel.

15. The method of claim 14, wherein the step of converting the original pixel comprises:
mx=Max(R,G,B)
mn=(R,G,B)=W
R′=R*(1+mn/255)−(mx/255)*W
G′=G*(1+mn/255)−(mx/255)*W
B′=B*(1+mn/255)−(mx/255)*W
wherein R, G and B respectively represent R, G and B original subpixels, R′, G′ and B′ respectively represent R, G and B converted subpixels, W represents the W subpixel, Max is a function that selects a greatest value in the set of R, G and B, and Min is a function that selects a least value in the set of R, G and B.

16. The method of claim 11, in the scaling down step, the plurality of scaled subpixels are determined by performing interpolation on the plurality of converted subpixels and the generated subpixel.

17. The method of claim 16, wherein the interpolation is linear interpolation.

18. The method of claim 12, in the scaling down step, the R, G, B and W scaled subpixels are respectively determined by performing linear interpolation on the R, G and B converted subpixels and the W subpixels.

19. The method of claim 11, further comprising a step of receiving the plurality of scaled subpixels and then outputting a plurality of data.

20. The method of claim 11, further comprising a step of performing gamma encoding on the plurality of original subpixels prior to the step of converting the original pixel.
